(19) United States
(12) Patent Application Publication
(10) Pub. No.: US 2015/0087461 A1
(43) Pub. Date: Mar. 26, 2015

(54) Banjo Type Rear Axle Assembly with Drop Out Third Member

(71) Applicants: James D. Jackson, Sah Lake City, UT (US); Phillip A. Rawlings, Midvale, UT (US)

(72) Inventors: James D. Jackson, Sah Lake City, UT (US); Phillip A. Rawlings, Midvale, UT (US)

(21) Appl. No.: 14/033,465

(22) Filed: Sep. 21, 2013

(51) Int. Cl. F16H 48/08; F16H 48/38

(52) U.S. Cl. CPC F16H 48/08; F16H 48/38
USPC 475/160

(57) ABSTRACT

The present invention is directed to a Banjo type axle assembly with a drop out third member carrier for the pinion shaft assembly, ring gear assembly, the rotatable differential house assembly and the differential bearing clamp assembly. Said drop out third member carrier and the rear axle housing are constructed sufficiently to house a 10.5 inch diameter ring gear. In one preferred embodiment the drive pinion assembly and the ring gear assembly exhibit a mild hypoid gear set orientation. In one preferred embodiment said drop out third member carrier has substantially uniform dimensions in thickness and has a symmetrical bolt pattern between a pinion shaft side and a non-pinion shaft side with a total of twelve bolts to affix said drop out third member to carrier to said rear axle housing. An oiling shelf has extra material to house pinion bolts as part of the pinion shaft assembly.

### CROSS-REFERENCES TO RELATED APPLICATIONS

This application claims the benefit of U.S. Provisional Application 61/704,301 No. filed Sep. 21, 2012.

### FIELD OF ART

This invention relates to rear drive axles and drop out third member carriers in banjo type axle assemblies.

### BACKGROUND

Rear drive axle assemblies with differentials are well known in the art of motor vehicles. The concept of bifurcating power from a single input into two different power outputs with the potential of having unequal power distribution between the outputs has been known in the art since the development of bevel gears and pinions by Onesiphore Pecqueur in 1827. Since the development of bevel gear sets, this art has been applied in an array of different motor vehicles and currently underlines the mechanical basis for distributing power for many rear axle assembly units. The common elements in the art of rear axle assemblies are the following: the drive pinion assembly, the ring gear assembly, the rotatable differential house assembly with a differential bevel and pinion gear set, the axle housing, the differential bearing clamp assembly, and the rear axle shafts.

In a common rear axle assembly, the drive pinion assembly communicates with the drive shaft assembly via a universal joint and transmits torque from the drive shaft assembly to the ring gear assembly. The drive pinion assembly articulates directly with the ring gear assembly as a spiral bevel gear set where the teeth from the pinion shaft assembly articulates with the teeth from the ring gear assembly. The pinion shaft transmits longitudinal torque, which rotates around the axis running between the front of the vehicle to the rear of the vehicle, to the ring gear set which translates the longitudinal torque into lateral torque, which rotates around the axis running between side one and side two of the vehicle.

In addition to translating longitudinal torque into lateral torque, the articulation between said teeth of the drive pinion assembly and said teeth from the ring gear assembly functions to create a ratio between the number of rotations of said pinion shaft assembly during period of time X per the number of rotations of said ring gear assembly during period of time X. This ratio in rotational rates is created because the ring gear assembly often has more teeth than the pinion shaft assembly, and as a consequence the pinion shaft assembly completes an entire rotation faster than the ring gear assembly completes an entire rotation. Some common ratios in rotational rates in the art between the pinion gear shaft assembly and ring gear assembly are: 3.21:1, 3.42:1, 3.73:1, 4.10:1, 4.56:1, 4.88:1, 5.13:1, and 5.38:1.

This ratio in rotational rates between the pinion shaft assembly and the ring gear assembly influences a vehicle's gas mileage, toque, acceleration, top velocity, and ability to climb hills. Where the ratio is greater between the pinion gear rotation per time and the ring gear assembly rotation per time (e.g. 5.38:1), there is an increase in the torque of the ring gear assembly per the input of the toque of the pinion shaft assembly, but inversely a reduction in the radians per second of the ring gear assembly per the radians per second of the pinion shaft assembly. This is based on basic principles involving lever arms where increases in length of the radius from the axis of rotation correlate with increases in torque. The increase of the torque of the ring gear assembly per input of torque of the pinion shaft assembly is associated with increases in vehicle's towing ability, initial acceleration, and hill climbing. However increases of the torque of the ring gear assembly per input of torque of the pinion shaft is associated with decreases in vehicle's gas mileage and top velocity as a consequence of the decrease of radians per second of the ring gear assembly.

While often correlated with the number of teeth of ring gear assemblies in the art, the diameter of the ring gear also influences the strength of the ring gear assembly and as a consequence the failure rate of the rear gear assembly. This correlation between diameter and strength results from being able to make the teeth wider in a ring gear with a larger diameter. Common ring gear assemblies range in diameters from 7.25 in. to 10.5 in.

The ring gear assembly is affixed to the differential house assembly, and as the ring gear rotates with said lateral torque, the differential house rotates accordingly. Within said differential house, the differential pinion and bevel gear set bifurcates the lateral torque from the ring gear into the first rear axle shaft and the second rear axle shaft. Said rear axle shafts communicate the divided lateral torque into first tire assembly and second tire assembly. The divided lateral torques in said first and second axle shafts can be substantially similar when the vehicle is driving in a substantially straight path and can be different where one of said axle shafts rotates faster than the other of said axle shafts sufficient when the vehicle is driving around a corner one of the said tire assemblies on the outside of the corner rotates faster than the other of the said tire assemblies on the inside of the corner.

Another factor that influences the bifurcation of said lateral torque within said differential house is the relative traction experienced between said first tire assembly and said second tire assembly. When said first tire assembly or alternatively said second tire assembly experiences less traction than the alternative tire assembly, then it will spin faster than the alternative tire assembly unless there is a means to lock said differential house to bifurcate the lateral torque substantially equally between said tire assemblies except when the vehicle drives around a corner. In the art, there are several mechanisms to lock said differential house or to compensate for differences in lateral torque resulting from differences in traction. These mechanisms include the following: limited-slip differentials, traction control systems, automatic differential lockers, selective differential lockers, and spools.

The axle housing can either be unitized such as in a Salisbury type axle assembly or have a drop out third member carrier such as in a Banjo type axle assembly. In a Salisbury type axle assembly, the pinion shaft assembly, the ring gear assembly, the rotatable differential house assembly and the ring gear clamp assembly are accessible through an aperture with a cover in the rear of the axle housing. The cover is affixed to the rest of the axle housing by bolts. While a Salisbury type axle assembly is more common than a Banjo type axle assembly, there are some disadvantages to this type of axle assembly. Because the axle housing is unitized, there is no easy mechanism to change the differential bevel gear set or ring gear assembly. To change the inner components of the Salisbury axle, one can either work underneath a vehicle or entirely remove the rear axle and brake assembly from the vehicle's chassis. This inhibits the ability of vehicle enthusiasts to access and replace easily differential houses and other components in the axle housing with replacement parts and after-market parts.

The Banjo type axle assembly has a drop out third member carrier for the pinion shaft assembly, ring gear assembly, the rotatable differential house assembly with a differential bevel and pinion gear set, and the ring gear clamp assembly. Commonly in the art, the drop out third member carrier is affixed to the rear axle housing with bolts. The pinion shaft is adjusted to engage teeth of the ring gear assembly with shims. Unlike the Salisbury axle, one can remove the drop out third member carrier to change or work on the inner components of the rear axle without having to remove the entire rear axle and brake assembly from the vehicle's chassis. The relative ease of removing the drop out third member carrier provides an advantage for competitive racers and recreational users who want to be able to adjust their rear axle's components to achieve optimal rotational ratios between the pinion shaft assembly and the ring gear assembly. It also allows vehicle enthusiasts the ability to install custom of after-market features to their rear gears including differential lock mechanisms. However, Banjo type axles in the art are not designed for 10.5 in diameter ring gears which impart strength and the ability of having higher lateral torque per input of longitudinal torque.

Regardless of whether an rear axle has a Banjo type axle assembly or a Salisbury type axle assembly, rear axles are known to fail while being driven over rough terrain. With the heightened popularity of off-road racing and recreational off-road driving, there is a need for a rear axle to be designed to be durable enough to not fail irrespective of the terrain. There is also the need for rear axle assemblies to have the capacity to have high lateral torque relative to the input of longitudinal torque so that vehicles with said rear axle assemblies can have increased initial acceleration, climbing power and towing capacity. There is a need for a rear axle to provide adequate clearance underneath a vehicle so that the vehicle does not get stuck while climbing over rough terrain. There is a need for a rear axle assembly where components can be easily repaired and after-market replacement parts can be easily installed so that racers and off-roading enthusiasts can easily repair broken rear axles in rough terrain and can achieve competitive advantages with specialized after-market parts.

Information associated with rear axle assemblies can be located in the following references: US832991, U.S. Pat. No. 1,950,034, U.S. Pat. No. 1,955,824, U.S. Pat. No. 1,973,905, U.S. Pat. Nos. 2,124,406, 2153287, U.S. Pat. No. 2,188,316, U.S. Pat. No. 2,561,335, U.S. Pat. No. 2,817,251, U.S. Pat. No. 3,270,583, U.S. Pat. No. 3,930,421 A, U.S. Pat. No. 4,004,472 A, U.S. Pat. No. 4,018,097 A, U.S. Pat. No. 4,221,138 A, U.S. Pat. No. 4,625,581 A, U.S. Pat. No. 4,787,267 A, U.S. Pat. No. 5,442,977 A, U.S. Pat. No. 5,480,360 A, U.S. Pat. No. 5,533,423 A, U.S. Pat. No. 5,584,777 A, U.S. Pat. No. 5,733,216 A, U.S. Pat. No. 5,938,558 A, U.S. Pat. No. 5,951,431 A, U.S. Pat. No. 6,176,152 B1, U.S. Pat. No. 6,436,002 B1, U.S. Pat. No. 6,595,085 B1, U.S. Pat. No. 6,645,113 B2, U.S. Pat. No. 6,743,136 B1, U.S. Pat. No. 6,976,929 B1, U.S. Pat. No. 7,004,277 B2, U.S. Pat. No. 7,223,192 B2, U.S. Pat. No. 7,320,659 B2, U.S. Pat. No. 7,827,882 B2, U.S. Pat. No. 7,866,433 B2, U.S. Pat. No. 8,152,680 B2, US832991, U.S. Pat. No. 8,371,415 B2, US20120316024 A1, EP1717486 A2, EP2446172 B1.

However, each of these references has one or more of the following deficiencies: references with Banjo type rear axles may not have enough space to house larger diameter ring gears which are associated with greater strength and higher ratio's between the radians per second of ring gear assembly and radians per second of the pinion shaft assembly; references with Salisbury axles do not allow for ease of accessing and replacing the differential housing; many references are not adequately designed for off-road conditions with sufficient clearance under the vehicle and structural materials; and many references are not designed for after-market parts or access ports for specialized features.

### SUMMARY

The present invention is directed to a Banjo type axle assembly with a drop out third member carrier for the pinion shaft assembly, ring gear assembly, the rotatable differential house assembly and the differential bearing clamp assembly. Said drop out third member carrier and the rear axle housing are constructed sufficiently to house a 10.5 inch diameter ring gear. In one preferred embodiment the drive pinion assembly and the ring gear assembly exhibit a mild hypoid gear set orientation. In one preferred embodiment said drop out third member carrier has substantially uniform dimensions in thickness and has a symmetrical bolt pattern between a pinion shaft side and a non-pinion shaft side with a total of twelve bolts to affix said drop out third member to carrier to said rear axle housing. An oiling shelf has extra material to house pinion bolts as part of the pinion shaft assembly.

### BRIEF DESCRIPTION OF THE DRAWINGS

These and other features, aspects, and advantages of the present invention will become better understood with regard to the following description, appended claims and accompanying drawings where:

FIG. 1 shows an anterior view of the rear axle assembly with the drop out third member carrier assembly and the body and shafts of the axle housing;

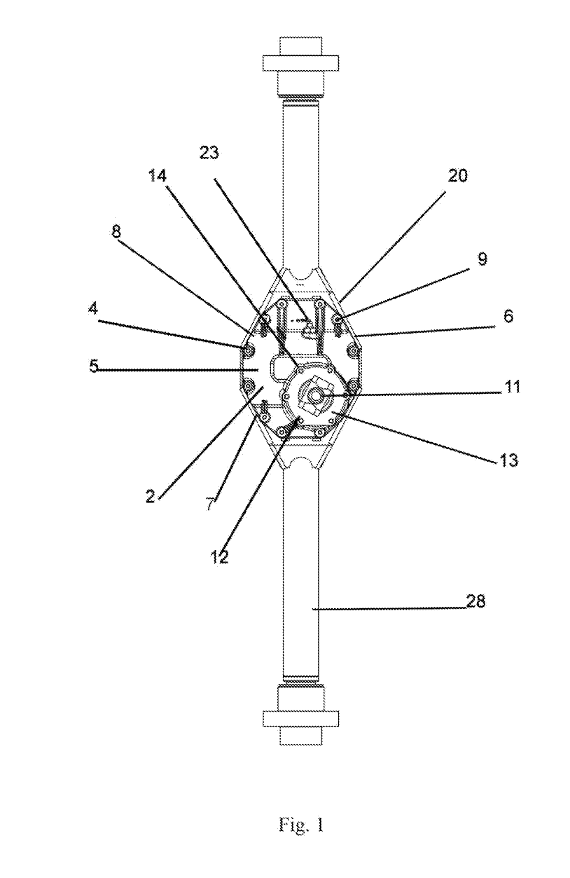

FIG. 2 shows an exploded view the rear axle assembly with the drop out third member carrier assembly, the drive pinion assembly and the body and shafts of the axle housing;

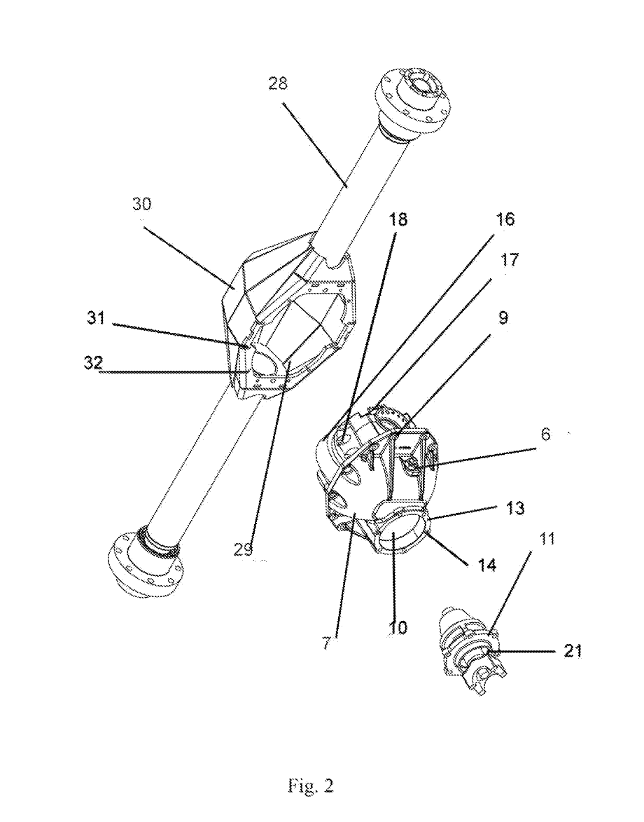

FIG. 3 shows a side view of the drop out third member carrier assembly with the rotatable differential house assembly;

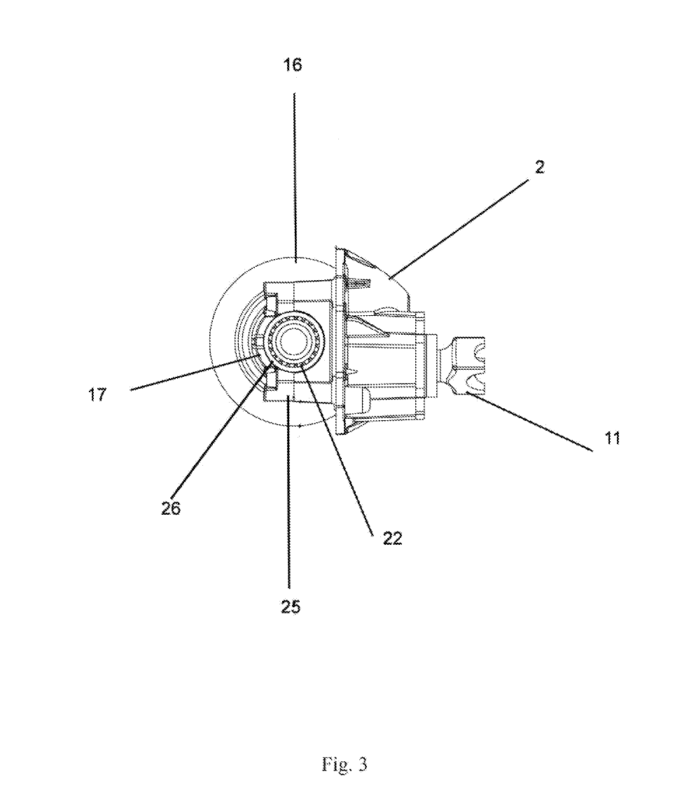

FIG. 4 shows an anterior view of the drop out third member carrier assembly;

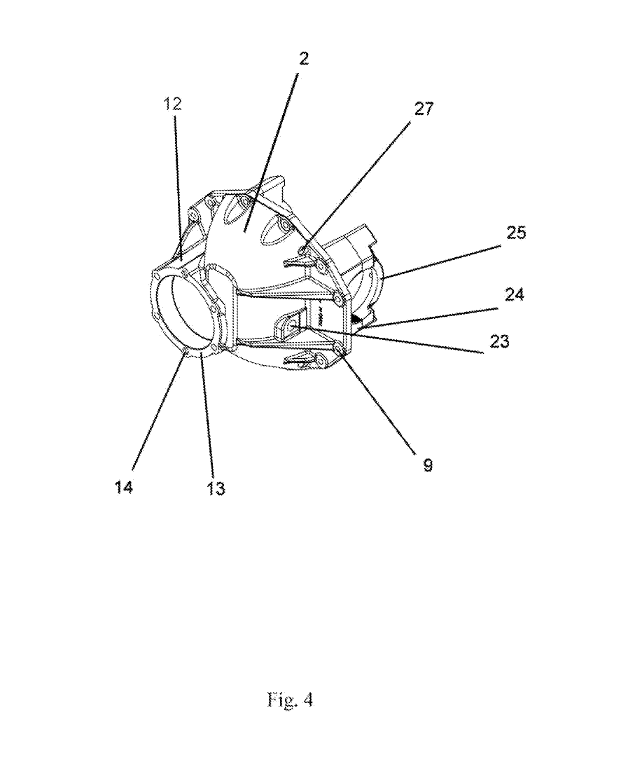

FIG. 5 shows a side view of the drop out third member carrier assembly without the rotatable differential house assembly; and

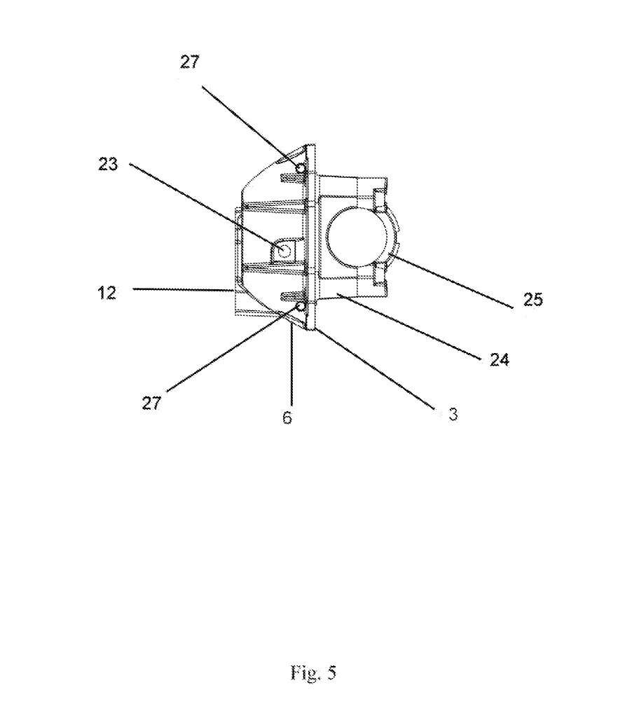

FIG. 6 shows a posterior side of the drop out third member carrier assembly.

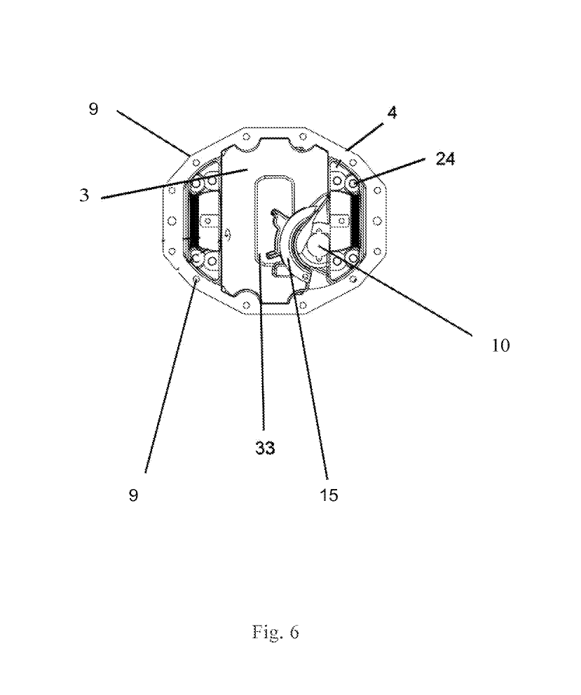

### DESCRIPTION

This description first defines the components of the present invention and then describes in the same order the preferred embodiments of said components.

### DEFINITIONS

1. “Drop out Third Member Carrier Assembly” 1—is a carrier apparatus with the fasteners necessary to affix to the axle housing and carries the drive pinion assembly 11, the ring gear assembly 16, the rotatable differential house assembly 17 with the differential bevel and pinion gear set, and the differential bearing clamp assembly 19.

2. “Drive Pinion Assembly” 11—is the drive pinion, pinion teeth, cups, bearings, shims, nuts, seals, and spacers necessary to translate longitudinal torque from the universal joint to the ring gear assembly 16 while traveling through an aperture in the drop out third member carrier assembly 10.

3. “Ring Gear Assembly” 16—is the ring gear with its teeth and fasteners necessary to articulate with the pinion teeth and affix to the rotatable differential house assembly 17; it functions to translate and transfer the longitudinal torque of pinion shaft assembly into lateral torque in the rotatable differential house assembly.

4. “Rotatable Differential House Assembly” 17—is a housing apparatus with the fasteners, bearings, shims cups, and bearings necessary to transfer the lateral torque of the ring gear assembly to the differential bevel and pinion gear set.

5. “Differential Bevel and Pinion Gear Set”—is pinion gears, washers, bevel gears, pinion shaft, and locking mechanism necessary to bifurcate the lateral torque communicated from the rotatable differential house assembly 17 and transfer it to the rear axle shaft assembly.

6. “Axle housing”—is a body 20 and two shafts 28 where the body is sufficient to be fastened to the drop out third member carrier assembly 1 and with said drop out third member carrier assembly houses 1 the drive pinion assembly 11, the ring gear assembly 16, the rotatable differential house assembly 17 with the differential bevel and pinion gear set, and the differential bearing clamp assembly 19. The two shafts of the axle housing 28 house the rear axle shaft assemblies.

7. “Differential Bearing Clamp Assembly” 19—is two bearing clamps with fasteners on either side of the differential housing that secure the differential bearings to the drop out third member carrier.

8. “Rear Axle Shaft Assembly”—is the two shafts, bearings, oil seals, that transfers the lateral torque from the differential bevel and pinion gear set to the first and second tire assemblies.

### Drop Out Third Member Carrier Assembly

One preferred embodiment of said drop out third member carrier assembly 1 has an exterior side 2 and an interior side 3. Said exterior side 2 is shaped in a convex orientation and faces a drive train of a vehicle. Said interior side 3 is shaped in a concave orientation and faces said body of said axle housing 20. Said exterior side 2 and interior side 3 have outer edges 4. Said drop out third member carrier assembly 1 has a top side 5 and a bottom side 6. Said top side 5 is the vertical half of said drop out third member assembly 1 that abuts the carriage of a vehicle where the input of the drive pinion assembly 11 is on an anterior side of said rear axle assembly 1. Said bottom side 6 is the vertical half of said drop out third member assembly 1 that faces the ground where the input of the drive pinion assembly 11 is on said anterior of said rear axle assembly. Said drop out third member carrier assembly 1 has a pinion drive side 7 and a non-pinion drive side 8. Said pinion drive side 7 is the horizontal half of said drop out third member carrier assembly 1 where a portion of the drive pinion assembly 11 substantially travels through it. The non-pinion drive side 8 is the horizontal half of said drop out third member carrier assembly 1 that substantially does not have a portion of the drive pinion assembly 11 traveling through it. In one preferred embodiment said outer edges 4 are substantially symmetrical along a vertical axis and a horizontal axis that respectively divide said top half from said bottom half and said pinion drive side 7 from said non-pinion drive side 8. In another preferred embodiment, said outer edges 4 have twelve sides and are shaped as a dodecagon.

In one preferred embodiment, said drop out third member carrier assembly 1 has an aperture 10 sufficiently large so that a portion of the drive pinion assembly can travel through it. Said aperture is substantially located on the pinion drive side 7. Said exterior side 2 has a sleeve 12 around said aperture 10 that protrudes from the exterior side 2. In one preferred embodiment, said sleeve 12 is substantially circular. In one preferred embodiment, said aperture 10 is oriented in a manner sufficient to have a mild hypoid mesh between the drive pinion teeth and the ring gear teeth. Said sleeve 12 has an outer lip 13. In one preferred embodiment, said outer lip 13 is substantially flat. Around said outer lip 13 there are holes 14 sufficient so fasteners can affix shims to said drop out third member carrier assembly. In one preferred embodiment of the fasteners, said fasteners are bolts. In one preferred embodiment of holes 14, said holes 14 are equidistantly spaced around the radius of said outer lip 13. In one preferred embodiment of said holes 14, there are six said holes 14.

In one preferred embodiment of the invention, said outer edges 4 of said exterior side 2 are rounded sufficient so that the said outer edges 4 are less likely to get stuck on rocks. Around said outer edges 4, one preferred embodiment has perforations 9 sufficiently large so fasteners can travel through said drop out third member carrier assembly 1 to the body of the axle housing 20 and affix said drop out third member carrier 1 to said body of the axle housing 20. In one preferred embodiment, said fasteners are bolts. In one preferred embodiment, there are twelve said perforations 9. In another preferred embodiment, said perforations 9 are symmetrically oriented around said outer edges 4 along said vertical axis and said lateral axis. Another preferred embodiment of invention said twelve perforations 9 are located at the angles of said dodecagon shape of said outer edges 4. In another preferred embodiment of said invention, the perforations 9 have equidistant depths between the exterior side 2 and the interior side 3 so the same length bolt can be used in each perforation 9. In another embodiment of said perforations 9, the material around the perforations 9 is oriented so it is not likely to deform in a manner covering said perforations when struck by an object.

One preferred embodiment of said interior side 3 there is an oiling shelf 15 located on a side of said aperture 10 for said drive pinion assembly 11. In one preferred embodiment said oiling shelf 15 is located on the medial side of said aperture 10 where the medial side is located towards the middle of said drop out third member carrier assembly 1 and conversely the lateral side is located towards said exterior sides 2. In one preferred embodiment, said oiling shelf 15 is oriented so it provides adequate lubrication even when the top side 5 and bottom side 6 are flipped so that the pinion drive assembly 1 is on the posterior side of the rear gear axle assembly. One preferred embodiment of the oiling shelf 15 is substantially semi-circular. In another preferred embodiment, the oiling shelf 15 is semi-circular with a medially oriented plate oriented in a manner to house said holes 14 of said sleeve 12 so said fasteners can have equidistant length.

Said interior side 3 is conversely shaped in a said concave orientation sufficient to carry and partially house the following: said drive pinion assembly 11, said ring gear assembly 16, said rotatable differential house assembly 17 with the differential bevel and pinion gear set, and said differential bearing clamp assembly 25. Said interior side 3 is oriented to reduce bearing movements of said drive pinion bearings 21 and said differential bearings 22. Said interior side 3 is oriented to reduce deflections between said ring gear assembly 16 and drive pinion assembly 11.

In one embodiment of said drop out third member carrier assembly 1, there is a passage 23 from the exterior side 2 to the interior side 3 where a load bolt can travel. Said load bolt is oriented so that it can minimize deflections between the pinion drive assembly 11 and the ring gear assembly 1. In one embodiment of said passage 23, the passage 23 is located laterally on the non-pinion side 8 of the drop out third member carrier assembly 1.

In one embodiment, said interior side 3 is shaped sufficiently to house a 10.5 inch diameter ring gear. One preferred embodiment of said interior side 3 has a rectangular shaped octagon 33 in the center of the interior side that is concave enough to house said ring gear assembly 16. In said octagon 33, two long sides are vertically oriented and communicate with four small angular oriented sides on the two long sides' top sides and bottom sides. Said four small angular oriented sides communicate with two horizontal sides that are smaller than the two long sides and bigger than said four small angular oriented sides. In one preferred embodiment, an inner surface in said octagon 33 is substantially flat. In another preferred embodiment the shape of said octagon 33 is interrupted by said oiling shelf 15 and said medially oriented plate.

Said interior side 3 has two mounting platforms 24 for the differential bearing clamp assembly 25. A first of said mounting platforms 24 is located on said pinion drive side 7 and a second of said mounting platforms 24 is located on said non-pinion drive side 8. First and second said mounting platforms 24 are located laterally from said octagon 33 and said aperture for the portion said drive pinion assembly 11 and are located medially from said outer edges 4. Said first and second mounting platforms 24 are designed to house half of two differential bearings 22 and two corresponding bearings caps 26 and affix to said differential bearing clamps 25. One embodiment of said first and second mounting platforms 24 is each of said platforms 24 has two affixing bases and one semi-circular cavity to house half of one said differential bearing 22 and half of one said differential bearing cap 26. Said semi-circular cavity is located between said two affixing bases which are oriented vertically above and below said semi-circular cavity. Between first and second said mounting platforms 24, there is a total of four affixing bases and two said semi-circular cavities. In one embodiment of said affixing bases, there is at least one opening on each affixing base where fasteners can affix said bearing clamps 25 to said affixing bases. One preferred embodiment has two said openings on each of said four affixing bases for a total of eight said openings. Said openings on said affixing bases can have substantially the same depth or different depth to provide weight savings. In one embodiment of the two said semi-circular cavities, the surfaces of said semi-circular cavities are threaded.

In one preferred embodiment, said drop out third member carrier 1 has ports 27 that travel from said exterior side 2 to said interior side 3. Said ports 27 allow for routing for an air locking mechanism. In one embodiment, there is a said port 27 that is on said top side 5 of said drop out third member carrier assembly 1 and a said port 27 on said bottom side 6 of said drop out third member carrier assembly 1.

Said drop out third member carrier assembly 1 can be constructed from a variety of materials including, but not limited to the following: steel, iron, titanium, beryllium, magnesium, copper, nodular iron, and from any metallic element or alloy of any metallic element that provides sufficient strength commonly known to ordinary people skilled in the art. In one preferred embodiment, said third member carrier assembly 1 is constructed from aluminum which has advantages over other materials by being lighter than many materials, but still providing sufficient strength. In another preferred embodiment, said third member carrier assembly 1 is constructed from nodular iron which is also known in the art as ductile iron. Said utilization of nodular iron in the construction has the benefits of dampening harmonics and being more impact resistant than aluminum.

### Drive Pinion and Ring Gear Assemblies

Said drive pinion assembly 1 includes the following components: drive pinion, pinion teeth, cups, bearings, shims, nuts, seals, and spacers. In different embodiments, said drive pinion has teeth sufficient to have the following rotational rate ratio with the ring gear assembly: 3.21:1, 3.42:1, 3.73:1, 4.10:1, 4.56:1, 4.88:1, 5.13:1, and 5.38:1. Said ring gear assembly includes the ring gear with its teeth and fasteners. In one embodiment, said ring gear has a 10.5 inch diameter. In said embodiment, said 10.5 inch diameter ring gear has teeth sufficient to have the following rotational rate ratio with the pinion drive assembly: 3.21:1, 3.42:1, 3.73:1, 4.10:1, 4.56:1, 4.88:1, 5.13:1, and 5.38:1.

### Rotatable Differential House Assembly with Differential Bevel and Pinion Gear Set

Said rotatable differential house assembly 17 includes the following components: a housing apparatus, fasteners, bearings, shims, cups, bearings, and space sufficient to house a differential bevel and pinion gear set. In one embodiment, said rotatable differential house 17 has a space to house a differential locking mechanism and air routing to control said differential locking mechanism. Said differential bevel and pinion gear set includes the following: pinion gears, washers, bevel gears, and pinion shaft. In one embodiment said differential bevel and pinion gear set includes a differential locking mechanism. Said differential locking mechanism in one embodiment is controlled via air routing.

### Rear Axle Housing

Said rear axle housing includes: a body 20, two shafts 28, and fasteners to be fastened to a chassis of a vehicle. Said body is shaped sufficient to be fastened to the drop out third member carrier assembly. Said body is also shaped sufficient to house with said drop out third member carrier the following: the drive pinion assembly, the ring gear assembly, the rotatable differential house assembly with the differential bevel and pinion gear set, and the differential bearing clamp assembly. In one embodiment, said body can house with said drop out third member carrier assembly 10.5 inch ring gear.

Said body 20 has an internal 29 and external side 30. Said internal side 29 is shaped in a concave orientation and abuts the drop out third member carrier assembly 1. Said external side 30 is shaped in a convex orientation and faces the opposite direction of the drive pinion assembly 11. Said internal side 29 and external sides 30 have outer borders 31. In one preferred embodiment said outer borders 31 are substantially symmetrical along a vertical axis and a horizontal axis. In another preferred embodiment, said outer borders 31 have twelve sides and are shaped as a dodecagon.

Around said outer border 31, one preferred embodiment has hollows 32 sufficiently large so fasteners can travel through said drop out third member carrier assembly 1 to the body of the axle housing and affix said drop out third member carrier 1 to said body of said axle housing 20. In one preferred embodiment, said fasteners are bolts. In one preferred embodiment, there are twelve said hollows 32. In another preferred embodiment, said hollows 32 are symmetrically oriented around said outer borders 31 along said vertical axis and said lateral axis. Another preferred embodiment of invention said twelve hollows 32 are located at the angles of said dodecagon shape of said outer borders 31.

Said shafts of the axle housing 28 are shaped to house the rear axle shaft assemblies. In one preferred embodiment said shafts 28 are tubular traveling from said body of the rear axle housing 20 to first and second wheel assemblies. In addition to said body 20 and said shafts 28, the rear axle housing includes fasteners to be fastened to the chassis of a vehicle. In one said embodiment the fasteners are bolts and travel through channels in the chassis and rear axle housing affixing them together.

### Differential Bearing Clamp Assembly

Said differential bearing clamp assembly 19 includes the following components: two bearing clamps 25 with fasteners on either side of the differential housing that secure the differential bearings to the drop out third member carrier 1. In one embodiment, two said bearing clamps 25 can be affixed to two said mounting platforms 24. Two said bearing clamps 25 are designed to house half of two differential bearings 22 and two corresponding bearings caps and affix to said mounting platforms 24. One embodiment of said bearing clamps 25 has two affixing legs attached to one semi-circular repository to house half of one said differential bearing and half of one said differential bearing cap. Said semi-circular repository is located between two said affixing legs which abut the mounting platforms 24. Between two said bearing clamps 25, there are a total of four affixing legs and two said semi-circular repositories. In one embodiment of said affixing legs, there is at least one pathway on each affixing base where fasteners can affix said bearing clamps to said affixing bases. One preferred embodiment has two said pathways on each of said four affixing legs for a total of eight said openings. In one embodiment of the two said semi-circular repositories, the surfaces of said semi-circular repositories are threaded.

### Rear Axle Shaft Assembly

Said rear axle shaft assembly including the following components: two shafts, bearings, oil seals, that transfers the lateral torque from the differential bevel and pinion gear set to the first and second tire assemblies.

Although the foregoing description contains many specifics, these should not be construed as limiting the scope of the invention or of any of the appended claims, but merely as providing information pertinent to some specific embodiments that may fall within the scopes of the invention and the appended claims. Features from different embodiments may be employed in combination. In addition, other embodiments of the invention may also be devised which lie within the scopes of the invention and the appended claims. The scope of the invention is, therefore, indicated and limited only by the appended claims and their legal equivalents. All additions, deletions and modifications to the invention, as disclosed herein, that fall within the meaning and scopes of the claims are to be embraced by the claims.

What is claimed is:

1. A rear axle assembly comprising:
(i) a drop out third member carrier assembly comprising an exterior side and an interior side;
(ii) said exterior side of said drop out third member carrier assembly is shaped in a convex orientation and faces a drive train of a vehicle;
(iii) said interior side of said drop out third member assembly is shaped in a concave orientation and faces said body of said axle housing;
(iv) said exterior side of said drop out third member assembly and interior side of said drop out third member carrier assembly have outer edges;
(v) said drop out third member carrier assembly has a top side and a bottom side;
(vi) said top side of said drop out third member carrier assembly is a first vertical half of said drop out third member assembly that abuts a carriage of said vehicle where an input of a drive pinion assembly is on an anterior side of said rear axle assembly;
(vii) said bottom side of said drop out third member carrier assembly is a second vertical half of said drop out third member assembly that faces ground where said input of said drive pinion assembly is on said anterior of said rear axle assembly;
(viii) said drop out third member carrier assembly has a pinion drive side and a non-pinion drive side;
(ix) said pinion drive side of said drop out third member carrier assembly is a first horizontal half of said drop out third member carrier assembly where a portion of said drive pinion assembly substantially travels through it;
(x) said non-pinion drive side of said drop out third member carrier assembly is a second horizontal half of said drop out third member carrier assembly that substantially does not have said portion of said drive pinion assembly traveling through it;
(xi) outer edges of said drop out third member carrier assembly are substantially symmetrical along a vertical axis of said drop out third member carrier assembly and a horizontal axis of said drop out third member carrier assembly that respectively divide said top side from said bottom side and said pinion drive side from said non-pinion drive side of said drop out third member carrier assembly;
(xii) said outer edges of said exterior side of said drop out third member carrier assembly are rounded sufficient so that the said outer edges of said drop out third member carrier assembly are less likely to get stuck on rocks;
(xiii) around said outer edges of said drop out third member carrier assembly are perforations sufficiently large so fasteners can travel through said drop out third member carrier assembly to a body of an axle housing and affix said drop out third member carrier to said body of said axle housing;
(xiv) said drop out third member carrier assembly comprises an aperture sufficiently large so that said portion of said drive pinion can travel through it;
(xv) said aperture is substantially located on the pinion drive side;
(xvi) said exterior side comprises a sleeve around said aperture that protrudes from the exterior side;
(xvii) said sleeve is substantially circular and oriented in a manner sufficient to have a mild hypoid mesh between drive pinion teeth and ring gear teeth;
(xviii) said sleeve has an outer lip;
(xix) said outer lip is substantially flat;
(xx) around said outer lip there are holes sufficient so fasteners can affix shims to said drop out third member carrier assembly;
(xxi) said interior side of said drop out third member carrier assembly comprises an oiling shelf located on a side of said aperture for said drive pinion;
(xxii) said oiling shelf is oriented so it provides adequate lubrication even when the top side and bottom side are flipped so that said input of said pinion drive assembly is on a posterior side of said vehicle;
(xxiii) said interior side of said drop out third member carrier assembly is shaped in said concave orientation sufficient to carry and partially house the following: said portion of the drive pinion assembly, a ring gear assembly, a rotatable differential house assembly with the differential bevel and pinion gear set, and said differential bearing clamp assembly;
(xxiv) said interior side of said drop out third member carrier assembly is oriented to reduce bearing movements of drive pinion bearings and differential bearings;
(xxv) said interior side of said drop out third member carrier assembly is oriented to reduce deflections between said ring gear assembly and pinion drive;
(xxvi) said drop out third member carrier assembly comprises a passage traveling from the exterior side of said drop out third member carrier assembly to the interior side of said drop out third member carrier assembly where a load bolt can travel;
(xxvii) said load bolt is oriented so that it can minimize deflections between said pinion drive assembly and said ring gear assembly;
(xxviii) said interior side of said drop out third member carrier assembly is shaped sufficiently to house a 10.5 inch diameter ring gear;
(xxix) said interior side drop out third member carrier assembly comprises two mounting platforms for a differential bearing clamp assembly;
(xxx) said differential bearing clamp assembly comprises the following components: two bearing clamps with fasteners on either side of the differential housing that secure the differential bearings to the drop out third member carrier;
(xxxi) two said bearing clamps can be affixed to two said mounting platforms; two said bearing clamps are designed to house half of two differential bearings and two corresponding bearings caps and affix to said mounting platforms;
(xxxii) a first of said mounting platforms is located on said pinion drive side and a second of said mounting platforms is located on said non-pinion drive side;
(xxxiii) said first and second mounting platforms are designed to house half of two differential bearings and two corresponding bearings caps and affix to said differential bearing clamps;
(xxxiv) said drive pinion assembly comprises the following components: a drive pinion, said pinion teeth, cups, bearings, shims, nuts, seals, and spacers;
(xxxv) said ring gear assembly includes the ring gear with said ring gear teeth and fasteners;
(xxxvi) said drop out third member carrier has ports that travel from said exterior side of said drop out third member carrier assembly to said interior side of said drop out third member carrier assembly;
(xxxvii) said ports allow for routing for a differential locking mechanism;
(xxxviii) said rotatable differential house assembly comprises the following components: a housing apparatus, fasteners, bearings, shims, cups, bearings, and space sufficient to house a differential bevel and pinion gear set;
(xxxix) said rotatable differential house has a space to house a differential locking mechanism and air routing to control said differential locking mechanism;
(xL) said differential bevel and pinion gear set comprises the following: pinion gears, washers, bevel gears, and pinion shaft;
(xLi) said differential bevel and pinion gear set interfaces with said differential locking mechanism, which is controlled via air routing;
(xLii) said rear axle housing includes: said body, two shafts, and fasteners to be fastened to said chassis of said vehicle;
(xLiii) said body is shaped sufficient to be fastened to said drop out third member carrier assembly;
(xLiv) said body is also shaped sufficient to house with said drop out third member carrier the following: said portion of said drive pinion assembly, said ring gear assembly, said rotatable differential house assembly with the differential bevel and pinion gear set, and said differential bearing clamp assembly;
(xLv) said body of said rear axle housing has an internal and external side;
(xLvi) said internal side of said body of the rear axle housing is shaped in a concave orientation and abuts said drop out third member carrier assembly;
(xLvi) said external side of the body of the rear axle housing is shaped in a convex orientation and faces an opposite direction from said input of said drive pinion assembly;
(xLvii) said internal side and external sides of said body of the rear axle housing have outer borders;
(xLix) said outer borders of the body of the rear axle housing are substantially symmetrical along a vertical axis and a horizontal axis;
(L) said outer borders of said body of the rear axle housing have hollows sufficiently large so fasteners can travel through said drop out third member carrier assembly to the body of the axle housing and affix said drop out third member carrier to said body of said axle housing;
(Li) said shafts of the axle housing are shaped to house a rear axle shaft assembly;
(Lii) said rear axle housing comprises fasteners to be fastened to said chassis of said vehicle;
(Liii) said rear axle shaft assembly comprises the following components: two shafts, bearings, oil seals, that transfers the lateral torque from the differential bevel and pinion gear set to the first and second tire assemblies.

2. A rear axle assembly according to claim 1 wherein said outer edges of said drop out third member carrier assembly are substantially symmetrical as a dodecagon along a vertical axis of said drop out third member carrier assembly and a horizontal axis of said drop out third member carrier assembly that respectively divide said top side from said bottom side and said pinion drive side from said non-pinion drive side of said drop out third member carrier assembly; and
said internal side and external sides of said body of the rear axle housing have outer borders said outer borders of the body of the rear axle housing are substantially symmetrical as a dodecagon along a vertical axis and a horizontal axis.

3. A rear axle assembly according to claim 1 wherein said interior side of said drop out third member carrier assembly comprises a rectangular shaped octagon in the center of the interior side that is concave enough to house said ring gear assembly; wherein said octagon, two long sides are vertically oriented and communicate with four small angular oriented sides on the two long sides' top sides and bottom sides; said four small angular oriented sides communicate with two horizontal sides that are smaller than the two long sides and bigger than said four small angular oriented sides.

4. A rear axle assembly according to claim 1 wherein one of said ports is on said top side of said drop out third member carrier assembly and another of said ports is on said bottom side of said drop out third member carrier assembly.

5. A rear axle assembly according to claim 1 wherein said oiling shelf is substantially semi-circular with a medially oriented plate oriented in a manner to house said holes of said sleeve so said fasteners can have equidistant length.
